(19) United States
(12) Patent Application Publication
(10) Pub. No.: US 2013/0051889 A1
(43) Pub. Date: Feb. 28, 2013

(54) INPUT DEVICE

(71) Applicants: Shinichiro Kimura, Miyagi-ken (JP); Shinji Hirano, Miyagi-ken (JP)

(72) Inventors: Shinichiro Kimura, Miyagi-ken (JP); Shinji Hirano, Miyagi-ken (JP)

(21) Appl. No.: 13/598,131

(22) Filed: Aug. 29, 2012

(30) Foreign Application Priority Data
Aug. 29, 2011 (JP) 2011-185601

(51) Int. Cl. B41J 5/12

(52) U.S. Cl. 400/490

(57) ABSTRACT

An input device includes detection parts detecting operation from the outside, a cap member receiving operation from the outside, and an operation part including an operating shaft. The cap member is locked to one end of the operating shaft and a flange portion, which transmits the operation received from the outside, is formed at the other end of the operating shaft. The operating shaft includes an engaging hole formed at one end-side end face of the operating shaft. The cap member includes a first fitting portion having elasticity, and a protruding portion formed at the first fitting portion so as to protrude toward the outside of the cap member. The one end of the operating shaft is press-fitted to the first fitting portion and the protruding portion of the cap member is positioned in the engaging hole, so that the cap member is locked to the operation part.

### CLAIM OF PRIORITY

This application claims benefit of Japanese Patent Application No. 2011-185601 filed on Aug. 29, 2011, which is hereby incorporated by reference in its entirety.

### BACKGROUND

1. Field of the Disclosure

The present disclosure relates to an input device, and more particularly, to an input device that uses a cap structure capable of reliably holding a cap in spite of the height of the input device being reduced.

2. Description of the Related Art

In recent years, the size and weight of portable electronic devices, such as a notebook PC, have been reduced so as to be more easily carried. The height of such portable electronic devices tends to be reduced in terms of the reduction in size.

Since the height of the portable electronic devices such as notebook PCs tends to be reduced, there is a demand for a reduction of the height of input devices used in these devices.

An input device disclosed in the following JP-A-2004-79298 is known as an input device in the related art.

The input device disclosed in JP-A-2004-79298 will be described below with reference to FIG. 12. FIG. 12 is a view showing an input device CT disclosed in JP-A-2004-79298.

As shown in FIG. 12, the input device CT disclosed in JP-A-2004-79298 includes a detection element SN that detects external operation, a cap CP that receives external operation, and an operation part IN that includes a protruding body LE. The cap CP is locked to one end of the protruding body LE, and a flange FL, which transmits the received external operation, is formed at the other end of the protruding body LE.

The cap CP includes a hole HL, which has a square cross-section and is formed in a recessed shape, and the protruding body LE is formed in the shape of a rectangular parallelepiped so as to have a square cross-section. One end of the protruding body LE is press-fitted to the hole HL, so that the cap CP of the input device CT disclosed in JP-A-2004-79298 is held at one end of the protruding body LE.

The input device CT is an input device where a force applied by the operation of the cap CP is transmitted to the detection element SN through the operation part IN and the detection element SN can distinguish a direction in which the operation part has been operated by detecting a change in a resistance value caused by strain generated due to the applied force.

If the cap CP is insufficiently held, it is not possible to proficiently detect the operation of the operation part despite operation of the operation part and a trouble, such as the coming-off of the cap CP, occurs.

In the input device CT, as an engagement area between the hole HL and one end of the protruding body LE, an area where a holding force capable of holding the cap without the looseness of the cap CP and without the separation of the cap CP from one end of the protruding body LE when the cap CP is operated is sufficiently obtained is secured by the press-fitting of one end of the protruding body LE to the hole HL.

According to the input device CT disclosed in JP-A-2004-79298, it is possible to obtain an engagement area sufficient to hold the cap CP as the engagement area between the cap CP and the protruding body LE and to obtain a holding force sufficient to hold the cap CP without the coming-off of the cap CP during the use of the input device even when the input device is used practically.

However, according to the cap structure of the input device CT, since the engagement area between the protruding body LE and the hole HL is reduced and the cap CP is thin, when the height of the input device CT is reduced, the hole HL is easily widened. Accordingly, the engagement between the cap CP and the protruding body CT is loose. For this reason, there is a concern that a holding force sufficient to hold the cap CP cannot be obtained.

### SUMMARY

An input device includes detection parts that detect external operation, a cap member that receives external operation, and an operation part that includes an operating shaft. The cap member is locked to one end of the operating shaft and a flange portion, which transmits the received external operation, is formed at the other end of the operating shaft. The operating shaft includes an engaging hole that is formed at the center of one end-side end face of the operating shaft in a recessed shape. The cap member includes a first fitting portion that has elasticity and is formed in a recessed shape, and a protruding portion that is formed at the innermost portion of the first fitting portion so as to protrude toward the outside of the cap member. The one end of the operating shaft is press-fitted to the first fitting portion and the protruding portion of the cap member is positioned in the engaging hole, so that the cap member is locked to the operation part.

### BRIEF DESCRIPTION OF THE DRAWINGS

FIG. 1 is a perspective view of an input device 1 and an input device 2;

FIG. 2 is a cross-sectional view of the input device 1;

FIG. 3 is a view showing an operation part 11;

FIG. 4 is a view showing a cap member 12;

FIG. 5 is a view showing a substrate 15;

FIG. 6 is a view showing a plate 14;

FIG. 7 is a view showing a protective sheet 16;

FIG. 8 is a view illustrating a positional relationship between the operation part 11 and detection parts 13;

FIG. 9 is a cross-sectional view of the input device 2;

FIG. 10 is a view showing an operation part 21;

FIG. 11 is a view showing a cap member 22; and

FIG. 12 is a view showing an input device CT.

### DESCRIPTION OF THE EXEMPLARY EMBODIMENTS

### First Embodiment

An input device 1 according to a first embodiment will be described below.

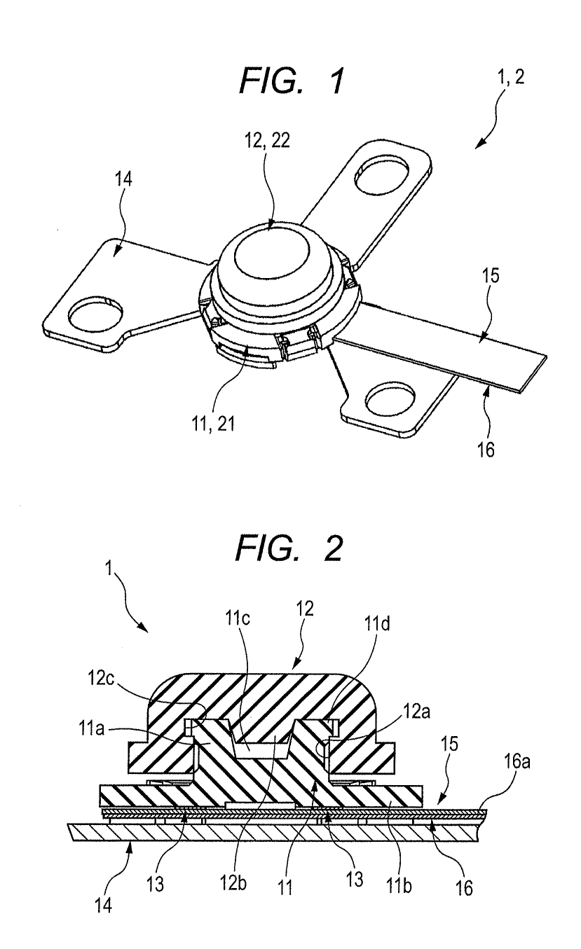

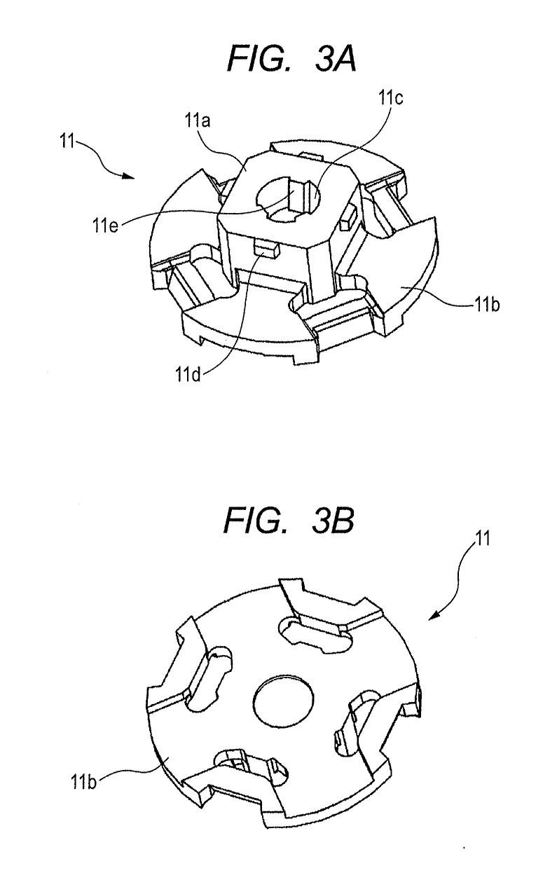

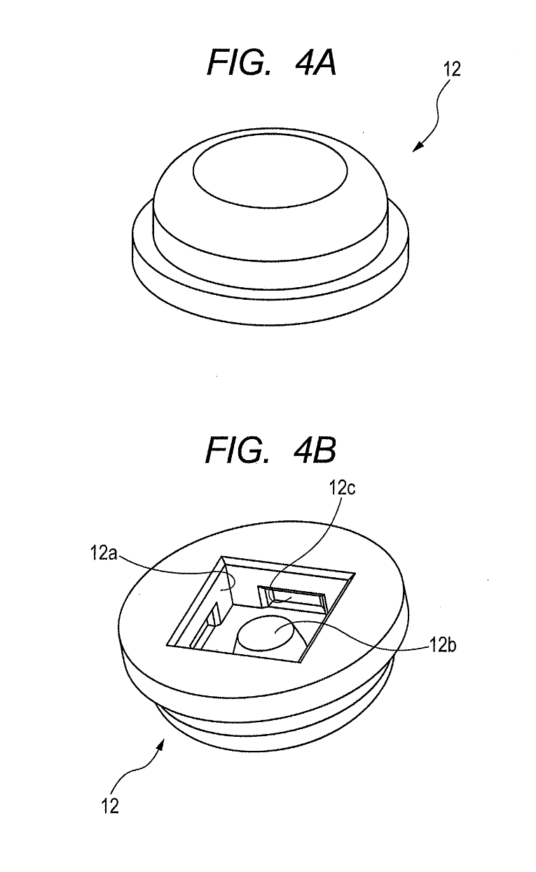

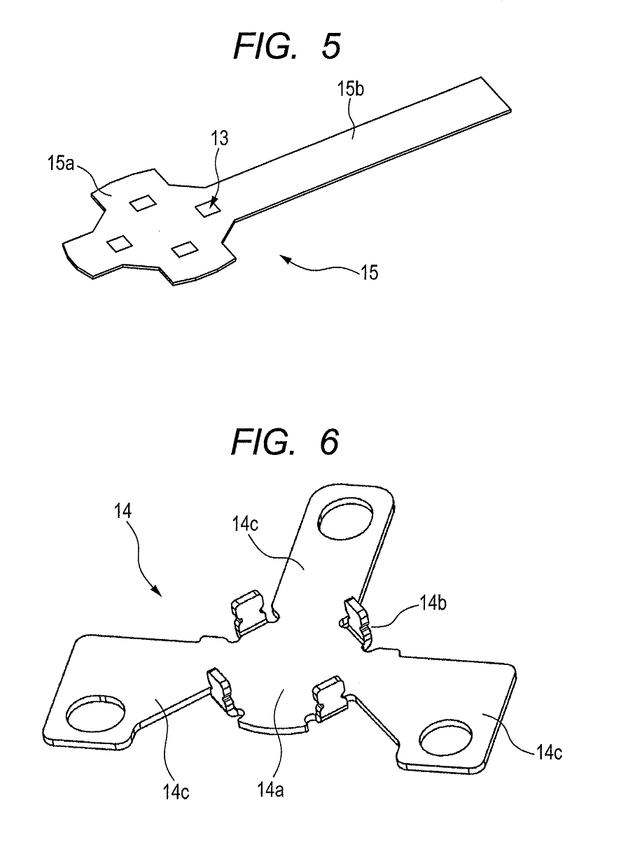

First, the structure of the input device 1 according to this embodiment will be described with reference to FIGS. 1 and 2. FIG. 1 is a perspective view of the input device 1 according to the first embodiment. FIG. 2 is a cross-sectional view of the input device 1. FIG. 3 is a view showing an operation part 11, FIG. 3A is a perspective view of the operation part 11 when the operation part 11 is viewed from the upper side thereof, and FIG. 3B is a perspective view of the operation part 11 when the operation part 11 is viewed from the lower side thereof. FIG. 4 is a view showing a cap member 12, FIG. 4A is a view showing the cap member 12 when the cap member 12 is viewed from the upper side thereof, and FIG. 4B is a view showing the cap member 12 when the cap member 12 is viewed from the lower side thereof. FIG. 5 is a view showing a substrate 15 that holds detection parts 13. FIG. 6 is a view showing a plate 14.

As shown in FIGS. 1 and 2, the input device 1 includes detection parts 13 that detect operation from the outside; a cap member 12 that receives operation from the outside; an operation part 11 that transmits the operation received by the cap member 12 to the detection parts 13; a substrate 15 that outputs detection results of the detection parts 13 to the outside; a plate 14 that integrally holds the operation part 11, the detection parts 13, and the substrate 15; and a protective sheet 16 that covers the substrate 15 so as to insulate and protect the substrate 15.

Next, the respective components will be described with reference to FIGS. 3 to 7.

As shown in FIGS. 3A and 3B, the operation part 11 is made of a synthetic resin material and includes an operating shaft 11a. The cap member 12 is locked to one end of the operating shaft 11a and a flange portion 11b, which transmits the operation received from the outside to the detection parts 13, is formed at the other end of the operating shaft 11a.

The operating shaft 11a is formed in the shape of a post of which a cross-section taken along a plane perpendicular to the direction of a line connecting one end of the operating shaft 11a with the other end of the operating shaft 11a has a polygonal shape, and the cross-section of the operating shaft 11a has a substantially square shape in this embodiment.

The operating shaft 11a includes an engaging hole 11c that is formed at the center of one end-side end face thereof in a recessed shape. Further, the operating shaft 11a includes hook portions 11d that are formed along the outer periphery of the one end-side end face so as to protrude outward. Rib portions 11e, which protrude toward the innermost portion of the engaging hole 11c from the outside of the engaging hole 11c, are formed at three positions on the inner surface of the engaging hole 11c at regular intervals.

Further, the flange portion 11b is formed around the other end-side end face of the operating shaft 11a at the other end of the operating shaft 11a in a disc shape.

As shown in FIG. 4, the cap member 12 is made of a synthetic rubber material such as NBR (Nitrile Butadiene Rubber) and is formed in a disc shape.

The cap member 12 includes a first fitting portion 12a that has elasticity and is formed on one surface thereof forming the bottom of the cap member 12 in a recessed shape, and a protruding portion 12b that is formed at the innermost portion of the first fitting portion 12a so as to protrude toward the outside of the cap member 12.

Moreover, the cross-section of the first fitting portion 12a is formed in a square shape, and the first fitting portion 12a includes locking portions 12c that are formed in a recessed shape on the inner surface of the first fitting portion 12a. The locking portions 12c are disposed at positions where the hook portions 11d and the locking portions 12c can be engaged with each other when the operating shaft 11a is inserted into the first fitting portion 12a.

As shown in FIG. 5, the substrate 15 is formed of a flexible resin film such as an FPC (Flexible Printed Circuit) board. The substrate 15 includes a base portion 15a and a connection portion 15b. The detection parts 13 are integrally formed on one surface of the base portion 15a by printing. The connection portion 15b is formed to extend from the base portion 15a and can be electrically connected to the outside.

Further, the detection parts 13 are disposed at positions corresponding to the respective corners of an imaginary square shape on one surface of the base portion 15a.

The detection part 13 is formed by printing a resistor on the substrate 15, is a strain sensor that detects the change of a resistance value caused by strain generated due to applied pressure, and detects the operation received from the outside by detecting the change of the resistance value with a strain sensor.

As shown in FIG. 6, the plate 14 is formed of a metal plate and includes a base portion 14a and mounting portions 14c. The base portion 14a includes four grippers 14b that are formed on the same circumference at regular intervals. The mounting portions 14c are formed to extend from the base portion 14a in three directions and are used to mount the input device 1. The grippers 14b are provided to extend from the base portion 14a in the same direction perpendicular to the base portion 14a.

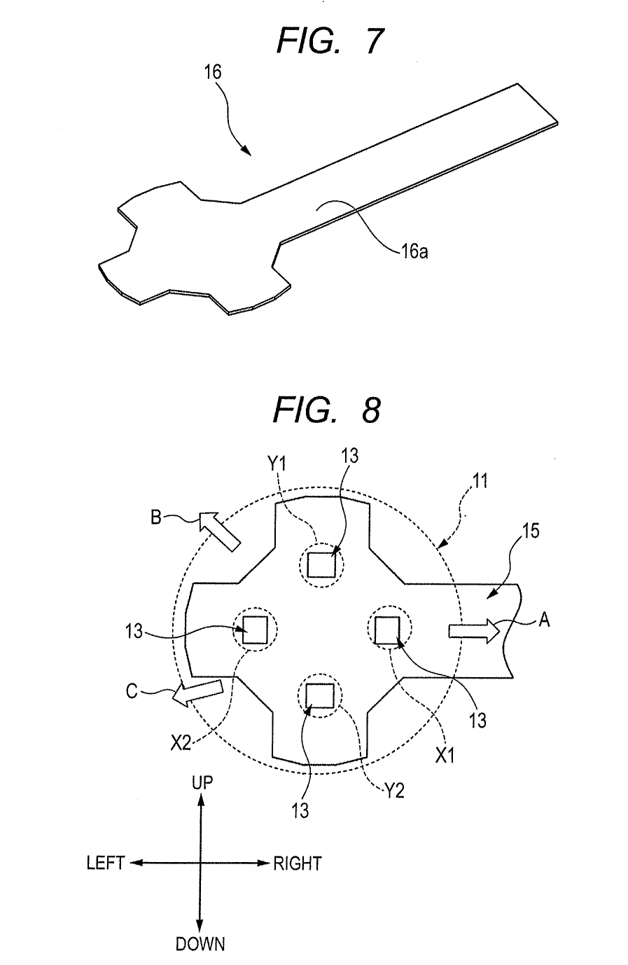

As shown in FIG. 7, the protective sheet 16 is made of a material that has flexibility and an insulating property, is formed in a shape corresponding to the shape of the substrate 15, and includes an adhesive surface 16a that is formed on one surface thereof. An adhesive is applied to the adhesive surface 16a.

Next, the structure of the input device 1 will be described with reference to FIGS. 2 and 5.

As shown in FIG. 2, the protective sheet 16 is superimposed and disposed so that the shape of the substrate 15 corresponds to the shape of the protective sheet 16 and the back surface of the surface of the substrate 15 on which the detection parts 13 are printed faces the adhesive surface 16a. Accordingly, the substrate 15 and the protective sheet 16 are formed integrally with each other.

The detection parts 13, the substrate 15, and the protective sheet 16, which are formed integrally, are disposed so that the protective sheet 16 and the plate 14 face each other and the base portion 15a is received in a region surrounded by the grippers 14b. The detection parts 13, the substrate 15, and the protective sheet 16 are fixed by adhesion.

The operation part 11 is superimposed and disposed on the substrate 15 in the region surrounded by the grippers 14b so that the flange portion 11b and the substrate 15 are engaged with each other. The operation part 11 is fixed to the substrate 15 by adhesion.

The grippers 14b are bent in the direction of the operating shaft 11a, respectively, so that the operation part 11, the detection parts 13, the substrate 15, and the protective sheet 16 are held integrally.

As shown in FIG. 2, one end of the operating shaft 11a of the operation part 11 is press-fitted to the first fitting portion 12a so that the hook portions 11d can be engaged with the locking portions 12c. In this case, the protruding portion 12b of the cap member 12 formed in the first fitting portion 12a is disposed in the engaging hole 11c formed at one end of the operating shaft 11a, so that the cap member 12 is locked to the operation part 11. Accordingly, the input device 1 is formed.

Next, the operation of the input device 1 will be described with reference to FIG. 8. FIG. 8 is a view illustrating a positional relationship between the operation part 11 and the detection parts 13.

When the cap member 12 of the input device 1 is operated by a finger or the like, the operation part 11 is pushed in the direction where a force is applied and presses the detection parts 13 disposed on the side where the operation part 11 is to be pushed. The pressed detection parts 13 detect the change of resistance values caused by strain generated due to applied pressure, so that the detection parts 13 detect the operation received from the outside.

When pressure applied to the detection parts 13 is increased, the change of the resistance values detected by the detection parts 13 is increased. When pressure applied to the detection parts 13 is reduced, the change of the resistance values is reduced. A direction where the operation part has been operated is determined on the basis of the change of the resistance values detected by the detection parts 13.

For example, when the operation part 11 is operated in the direction of an arrow A (to the right side) as shown in FIG. 8, it is determined that the operation part 11 is operated in the direction of the arrow A if it is detected that a resistance value detected by the detection part 13 disposed at a position X1 is increased and it is detected that a resistance value detected by the detection part 13 disposed at a position X2 is reduced.

Further, when the operation part 11 is operated in the direction of an arrow B (to the upper left side at an angle of 45°), it is determined that the operation part 11 is operated in the direction of the arrow B if it is detected that resistance values detected by the detection parts 13 disposed at the position X2 and a position Y1 are increased and it is detected that resistance values detected by the detection parts 13 disposed at the position X1 and a position Y2 are reduced.

Furthermore, it is possible to more accurately detect the direction, where the operation part has been operated, by comparing the change of the resistance values that are detected by the detection parts 13 disposed at the four positions.

For example, when the operation part 11 is operated in the direction of an arrow C (to the lower left side at an angle of 0 to 45°), it is determined that the operation part 11 is operated in a direction toward the lower left side if it is detected that resistance values detected by the detection parts 13 disposed at the positions X2 and Y2 are increased and it is detected that resistance values detected by the detection parts 13 disposed at the positions X1 and Y1 are reduced. In addition, it is determined that the operation part 11 is operated in the direction of an arrow C if the amount of the change of a resistance value detected by the detection part 13 disposed at the position X2 is larger than the amount of the change of a resistance value detected by the detection part 13 disposed at the position Y2 and the amount of the change of a resistance value detected by the detection part 13 disposed at the position X1 is larger than the amount of the change of a resistance value detected by the detection part 13 disposed at the position Y1.

The effects of this embodiment will be described below.

The input device 1 according to this embodiment includes the detection parts 13 that detect operation from the outside; the cap member 12 that receives operation from the outside; and the operation part 11 that includes the operating shaft 11a. The cap member 12 is locked to one end of the operating shaft 11a and the flange portion 11b, which transmits the operation received from the outside, is formed at the other end of the operating shaft 11a. The operating shaft 11a includes the engaging hole 11c that is formed at the center of one end-side end face thereof in a recessed shape. The cap member 12 includes the first fitting portion 12a that has elasticity and is formed in a recessed shape, and the protruding portion 12b that is formed at the innermost portion of the first fitting portion 12a so as to protrude toward the outside of the cap member 12. One end of the operating shaft 11a is press-fitted to the first fitting portion 12a and the protruding portion 12b of the cap member 12 is positioned in the engaging hole 11c, so that the cap member 12 is locked to the operation part 11.

Accordingly, the reduction of a holding force between the cap member 12 and the operating shaft 11a, which is a concern for the reduction of the height of the input device 1 and is caused since the first fitting portion 12a is easily widened due to the reduction of the thickness of the cap member 12, is prevented by forming the protruding portion 12b at the innermost portion of the first fitting portion 12a to reinforce the cap member 12 so that the first fitting portion 12a is not easily widened. Therefore, it is possible to obtain an effect of securing a holding force sufficient to hold the cap member 12 on the operating shaft 11a and an effect of preventing the cap member 12 from coming off.

Further, since the looseness of the cap member 12 is removed due to this, it is possible to obtain an effect of improving operation feeling at the time of an operation.

Furthermore, in the input device 1 according to this embodiment, the operating shaft 11a includes the hook portions 11d that are formed along the outer periphery of the one end-side end face thereof so as to protrude outward and the first fitting portion 12a includes the locking portions 12c that are formed in a recessed shape on the inner surface of the first fitting portion 12a.

Accordingly, since the hook portions 11d that are formed along the outer periphery of the one end-side end face of the operating shaft 11a so as to protrude outward and the locking portions 12c that are formed in a recessed shape along the inner surface of the first fitting portion 12a are provided, the hook portions 11d and the locking portions 12c are engaged with each other and the cap member 12 is not more easily separated from the operating shaft 11a when the cap member 12 is locked to the operating shaft 11a. Therefore, it is possible to obtain an effect of more reliably preventing the cap member 12 from coming off.

Moreover, in the input device 1 according to this embodiment, the detection parts 13 detect the operation from the outside by detecting a change in pressure.

Accordingly, since the detection parts detect operation from the outside by detecting a change in pressure, it is possible to operate the input device 1 by lightly operating the operation part 11. Therefore, it is possible to obtain an effect of being capable of reducing the size of the input device as compared to a case where a switch, a variable resistor, or the like is used.

Further, in the input device 1 according to this embodiment, the rib portions 11e, which protrude toward the innermost portion of the engaging hole 11c from the outside of the engaging hole 11c, are formed on the inner surface of the engaging hole 11c.

Accordingly, since the rib portions 11e, which protrude toward the innermost portion of the engaging hole 11c from the outside of the engaging hole 11c, are formed on the inner surface of the engaging hole 11c, a fitting force between the protruding portion 12b and the engaging hole 11c is further increased. Therefore, the cap member 12 is not easily separated, so that it is possible to obtain an effect of being capable of more reliably preventing the cap member 12 from coming off.

Moreover, in the input device 1 according to this embodiment, the rib portions 11e are formed at three positions at regular intervals. Since the rib portions 11e are formed at three positions at regular intervals, it is possible to obtain an effect of being capable of fitting the protruding portion 12b to the engaging hole 11c in a good balance with a few rib portions 11e and an effect of being capable of more reliably preventing the cap member 12 from coming off.

Further, in the input device 1 according to this embodiment, the cross-section of the operating shaft 11a taken along a plane perpendicular to the direction of a line connecting one end of the operating shaft 11a with the other end of the operating shaft 11a has a polygonal shape.

Accordingly, since the cross-section of the operating shaft 11a has a polygonal shape, the cap member 12 is not easily rotated about the operating shaft 11a even though the cap member 12 receives operation from the outside and the fitting force between the operating shaft 11a and the cap member 12 is not easily reduced. Therefore, it is possible to obtain an effect of being capable of more reliably preventing the cap member 12 from coming off.

Further, it is possible to obtain an effect of easily attaching the operating shaft 11a to the cap member 12 due to this.

Furthermore, since the cross-section of the operating shaft 11a has a substantially square shape in the input device 1 according to this embodiment, it is possible to obtain an effect of more reliably and easily transmitting operating pressure to the detection parts 13 that are disposed around the operating shaft 11a.

### Second Embodiment

An input device 2 according to a second embodiment will be described below. The components of the input device 2 are the same as those of the input device 1 according to the first embodiment, but the input device 2 is different from the input device 1 in terms of a locking structure between the operation part 11 and the cap member 12. In the following description, the same components as the components of the first embodiment are denoted by the same reference numerals as the reference numerals used in the description of the first embodiment and the detailed description thereof will be omitted.

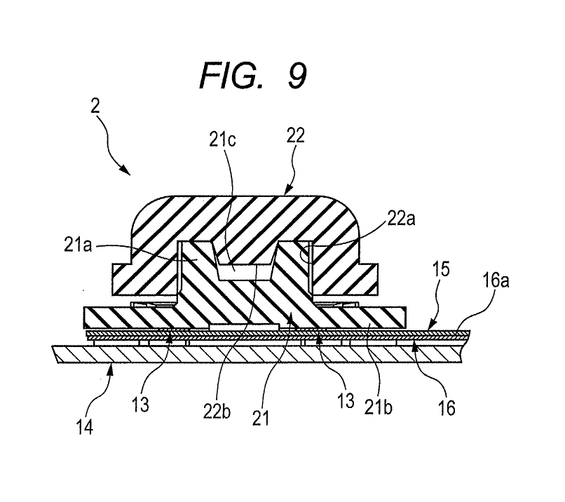

First, the structure of the input device will be described with reference to FIGS. 1 and 9. FIG. 9 is a cross-sectional view of the input device 2. Meanwhile, since the appearance of the input device 2 is the same as that of the input device 1, FIG. 1 is used.

As shown in FIGS. 1 and 9, the input device 2 includes detection parts 13 that detect operation from the outside; a cap member 22 that receives operation from the outside; an operation part 21 that transmits the operation received by the cap member 22 to the detection parts 13; a substrate 15 that outputs detection results of the detection parts 13 to the outside; a plate 14 that integrally holds the operation part 21, the detection parts 13, and the substrate 15; and a protective sheet 16 that covers the substrate 15 so as to insulate and protect the substrate 15.

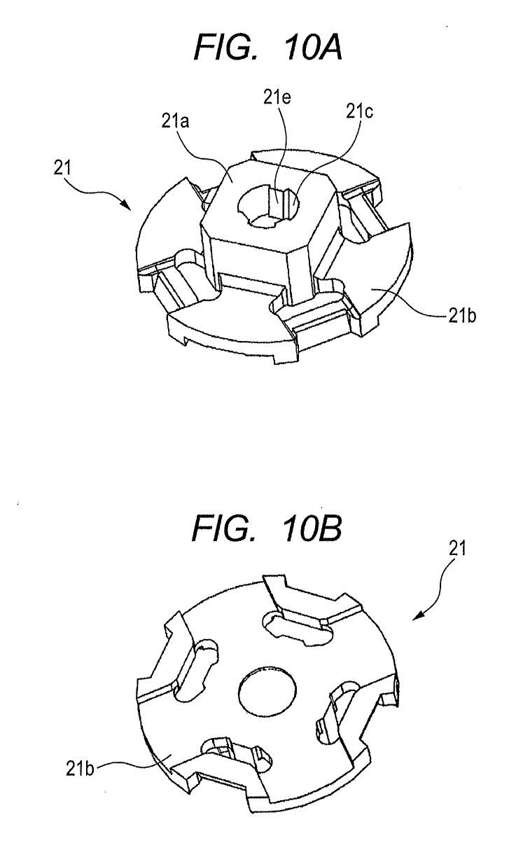

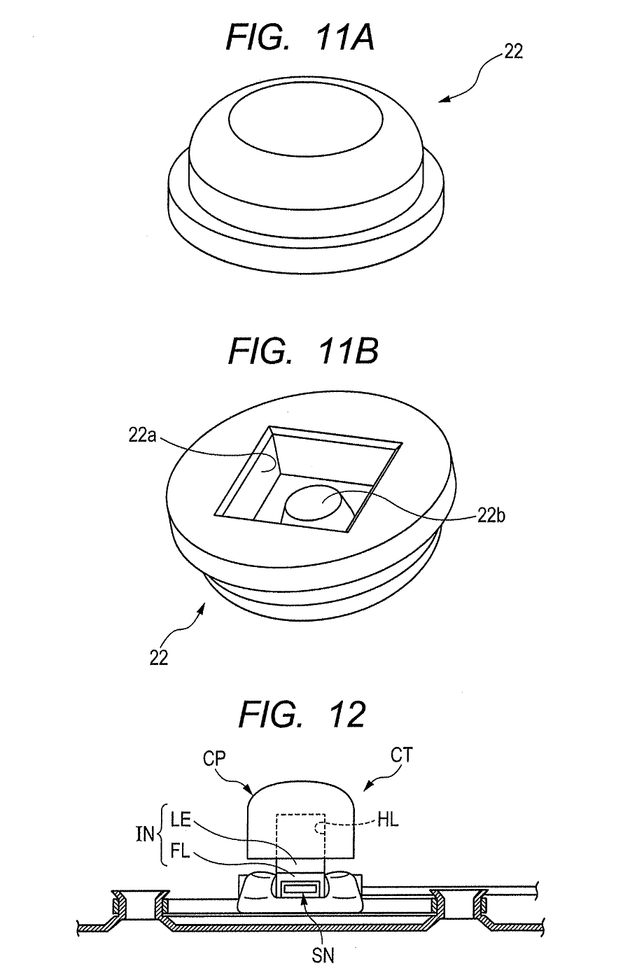

Next, the respective components will be described with reference to FIGS. 10 and 11. FIG. 10 is a view showing the operation part 21, FIG. 10A is a perspective view of the operation part 21 when the operation part 21 is viewed from the upper side thereof, and FIG. 10B is a perspective view of the operation part 21 when the operation part 21 is viewed from the lower side thereof. FIG. 11 is a view showing the cap member 22, FIG. 11A is a view showing the cap member 22 when the cap member 22 is viewed from the upper side thereof, and FIG. 11B is a view showing the cap member 22 when the cap member 22 is viewed from the lower side thereof.

As shown in FIG. 10, the operation part 21 is made of a synthetic resin material and includes an operating shaft 21a. The cap member 22 is locked to one end of the operating shaft 21a and a flange portion 21b, which transmits the operation received from the outside to the detection parts 13, is formed at the other end of the operating shaft 21a.

The operating shaft 21a is formed in the shape of a post of which a cross-section taken along a plane perpendicular to the direction of a line connecting one end of the operating shaft 21a with the other end of the operating shaft 21a has a polygonal shape, and the cross-section of the operating shaft 21a has a substantially square shape in this embodiment.

The operating shaft 21a includes an engaging hole 21c that is formed at the center of one end-side end face thereof in a recessed shape. Rib portions 21e, which protrude toward the innermost portion of the engaging hole 21c from the outside of the engaging hole 21c, are formed at three positions on the inner surface of the engaging hole 21c at regular intervals.

Further, the flange portion 21b is formed around the other end-side end face of the operating shaft 21a at the other end of the operating shaft 21a in a disc shape.

As shown in FIG. 11, the cap member 22 is made of a synthetic rubber material such as NBR (Nitrile Butadiene Rubber) and is formed in a disc shape.

The cap member 22 includes an attachment portion 22a that has elasticity and is formed on one surface thereof forming the bottom of the cap member 22 in a recessed shape, and a fitting portion 22b that is formed at the innermost portion of the attachment portion 22a so as to protrude toward the outside of the cap member 22.

Further, the cross-section of the attachment portion 22a is formed in a square shape.

As in the first embodiment, the detection part 13 is a strain sensor that detects the change of a resistance value caused by strain generated due to applied pressure, and detects the operation received from the outside by detecting a change in pressure with a strain sensor.

The substrate 15 is the same as the substrate 15 used in the first embodiment.

The plate 14 is the same as the plate 14 used in the first embodiment.

The protective sheet 16 is the same as the protective sheet 16 used in the first embodiment.

Next, the structure of the input device 2 will be described with reference to FIGS. 1 and 9.

As shown in FIGS. 1 and 9, the protective sheet 16 is superimposed and disposed so that the shape of the substrate 15 corresponds to the shape of the protective sheet 16 and the back surface of the surface of the substrate 15 on which the detection parts 13 are printed faces an adhesive surface 16a. Accordingly, the substrate 15 and the protective sheet 16 are formed integrally with each other.

The detection parts 13, the substrate 15, and the protective sheet 16, which are formed integrally, are disposed so that the protective sheet 16 and the plate 14 face each other and a base portion 15a is received in a region surrounded by grippers 14b. The detection parts 13, the substrate 15, and the protective sheet 16 are fixed by adhesion.

The operation part 21 is superimposed and disposed on the substrate 15 in the region surrounded by the grippers 14b so that the flange portion 21b is positioned on the substrate 15. The operation part 21 is fixed to the substrate 15 by adhesion.

The grippers 14b are bent in the direction of the operating shaft 21a, respectively, so that the operation part 21, the detection parts 13, the substrate 15, and the protective sheet 16 are held integrally.

As shown in FIGS. 1 and 9, one end of the operating shaft 21a is inserted into the attachment portion 22a. In this case, the fitting portion 22b of the cap member 22 formed in the attachment portion 22a is press-fitted to the engaging hole 21c formed at one end of the operating shaft 21a, so that the cap member 22 is locked to the operation part 11.

The operation of the input device 2 is the same as the operation of the input device 1.

The effects of this embodiment will be described below.

The input device 2 according to this embodiment includes the detection parts 13 that detect operation from the outside; the cap member 22 that receives operation from the outside; and the operation part 21 that includes the operating shaft 21a. The cap member 22 is locked to one end of the operating shaft 21a and the flange portion 21b, which transmits the operation received from the outside, is formed at the other end of the operating shaft 21a. The operating shaft 21a includes the engaging hole 21c that is formed at the center of one end-side end face thereof in a recessed shape. The cap member 22 includes the attachment portion 22a that has elasticity and is formed in a recessed shape, and the fitting portion 22b that is formed at the innermost portion of the attachment portion 22a so as to protrude toward the outside of the cap member 22. One end of the operating shaft 21a is inserted into the attachment portion 22a and the fitting portion 22b is press-fitted to the engaging hole 21c, so that the cap member 22 is locked to the operation part 21.

Accordingly, one end of the operating shaft 21a is inserted into the attachment portion 22a and the fitting portion 22b is press-fitted to the engaging hole 21c, so that the cap member 22 is locked to the operation part 21. Therefore, it is possible to allow the cap member 22 to hold the operating shaft 21a from the inside. As a result, even when the length of the operating shaft 21a and the depth of the attachment portion 22a are reduced by the reduction of the height of the input device 2, it is possible to secure a holding force sufficient to hold the cap member 22. Accordingly, it is possible to obtain an effect of preventing the cap member 22 from coming off.

In the input device 2 according to this embodiment, the detection parts 13 detect the operation from the outside by detecting a change in pressure.

Accordingly, since the detection parts detect operation from the outside by detecting a change in pressure, it is possible to operate the input device 2 by lightly operating the operation part 21. Therefore, it is possible to obtain an effect of being capable of reducing the size of the input device.

In the input device 2 according to this embodiment, the rib portions 21e, which protrude toward the innermost portion of the engaging hole 21c from the outside of the engaging hole 21c, are formed on the inner surface of the engaging hole 21c.

Accordingly, since the rib portions 21e, which protrude toward the innermost portion of the engaging hole 21c from the outside of the engaging hole 21c, are formed on the inner surface of the engaging hole 21c, a fitting force between the fitting portion 22b and the engaging hole 21c is further increased. Therefore, the cap member 22 is not easily separated, so that it is possible to obtain an effect of being capable of more reliably preventing the cap member 22 from coming off.

In the input device 2 according to this embodiment, the cross-section of the operating shaft 21a taken along a plane perpendicular to the direction of a line connecting one end of the operating shaft 21a with the other end of the operating shaft 21a has a polygonal shape.

Accordingly, since the cross-section of the operating shaft 21a has a polygonal shape, it is possible to obtain an effect of preventing the cap member 22 from being rotated about the operating shaft 21a and an effect of being capable of more reliably preventing the cap member 22 from coming off even though the cap member 22 receives operation from the outside.

Further, it is possible to obtain an effect of easily attaching the cap member 22 to the operating shaft 21a due to this.

The input devices 1 and 2 according to the embodiments of the invention have been described specifically as described above. However, the invention is not limited to the above-mentioned embodiments and may have various modifications without departing from the scope of the invention. For example, the invention may have modifications as described below, and these modifications are also included in the scope of the invention.

(1) The appearances of the cap members 12 and 22 substantially have had the shape of a disc. However, the shapes of the appearances of the cap members may be changed into an arbitrary shape in consideration of operability and the like, and grooves or protrusions may be formed on the surfaces of the cap members so that the cap members do not slide more easily. Accordingly, it is possible to obtain an effect of improving the operability of the input devices 1 and 2.
(2) In the first and second embodiments, the mounting portions 14c have been formed to extend from the base portion 14a in three directions. However, the shape of the mounting portion may be changed depending on a place in which the input devices 1 and 2 are mounted or a method of mounting the input devices 1 and 2.
(3) The detection parts 13 have been pressed by the flange portion 11b in the first and second embodiments. However, a surface on which the detection parts 13 are disposed may be a back surface of the substrate 15 in the first and second embodiments and the detection parts 13 may be pressed by the flange portion 11b with the substrate 15 interposed between the flange portion 11b and the detection parts 13.

It should be understood by those skilled in the art that various modifications, combinations, sub-combinations and alterations may occur depending on design requirements and other factors insofar as they are within the scope of the appended claims of the equivalents thereof.

What is claimed is:

1. An input device comprising:
detection parts that detect operation from the outside;
a cap member that receives operation from the outside; and
an operation part that includes an operating shaft, the cap member being locked to one end of the operating shaft and a flange portion, which transmits the operation received from the outside, being formed at the other end of the operating shaft,
wherein the operating shaft includes an engaging hole formed at the center of one end-side end face of the operating shaft in a recessed shape,
the cap member includes a first fitting portion that has elasticity and is formed in a recessed shape, and a protruding portion that is formed at the innermost portion of the first fitting portion so as to protrude toward the outside of the cap member, and
the one end of the operating shaft is press-fitted to the first fitting portion and the protruding portion of the cap member is positioned in the engaging hole, so that the cap member is locked to the operation part.

2. The input device according to claim 1,
wherein the operating shaft includes hook portions that are formed along the outer periphery of the one end-side end face so as to protrude outward, and
the first fitting portion includes locking portions that are formed in a recessed shape on an inner surface of the first fitting portion.

3. The input device according to claim 1,
wherein the detection parts detect the operation, which is received from the outside, by detecting a change in pressure.

4. The input device according to claim 1,
wherein rib portions, which protrude toward the innermost portion of the engaging hole from the outside of the engaging hole, are formed on the inner surface of the engaging hole.

5. The input device according to claim 1,
wherein the cross-section of the operating shaft taken along a plane perpendicular to the direction of a line connecting one end of the operating shaft with the other end of the operating shaft has a polygonal shape.

6. The input device according to claim 2,
wherein the cross-section of the operating shaft taken along a plane perpendicular to the direction of a line connecting one end of the operating shaft with the other end of the operating shaft has a polygonal shape.

7. An input device comprising:
detection parts that detect operation from the outside;
a cap member that receives operation from the outside; and
an operation part that includes an operating shaft, the cap member being locked to one end of the operating shaft and a flange portion, which transmits the operation received from the outside, being formed at the other end of the operating shaft,
wherein the operating shaft includes an engaging hole formed at the center of one end-side end face of the operating shaft in a recessed shape,
the cap member includes an attachment portion that has elasticity and is formed in a recessed shape, and a second fitting portion that is formed at the innermost portion of the attachment portion so as to protrude toward the outside of the cap member, and
one end of the operating shaft is inserted into the attachment portion and the second fitting portion is press-fitted to the engaging hole, so that the cap member is locked to the operation part.

8. The input device according to claim 7,
wherein the detection parts detect the operation, which is received from the outside, by detecting a change in pressure.

9. The input device according to claim 7,
wherein rib portions, which protrude toward the innermost portion of the engaging hole from the outside of the engaging hole, are formed on the inner surface of the engaging hole.

10. The input device according to claim 7,
wherein the cross-section of the operating shaft taken along a plane perpendicular to the direction of a line connecting one end of the operating shaft with the other end of the operating shaft has a polygonal shape.
